(19) United States
(12) Patent Application Publication
(10) Pub. No.: US 2024/0231424 A1
(43) Pub. Date: Jul. 11, 2024

(54) COMPUTER SCREEN BLIND DEVICE

(71) Applicant: Eddie Smith, Pottstown, PA (US)

(72) Inventor: Eddie Smith, Pottstown, PA (US)

(21) Appl. No.: 18/528,905

(22) Filed: Dec. 5, 2023

Related U.S. Application Data
(60) Provisional application No. 63/437,382, filed on Jan. 6, 2023.

(51) Int. Cl. G06F 1/16; E06B 9/40

(52) U.S. Cl. CPC G06F 1/1609; E06B 9/40

(57) ABSTRACT

A novel computer screen blind device. The device is a unique window blind and computer monitor combined into a single device. The computer screen blind device comprises a body component comprised of a computer monitor/screen implemented into a window frame that is covered with a decorative window blind component. Thus, when the window blind component is retracted, the computer monitor/screen is revealed. The computer monitor/screen would function via Bluetooth or wireless technologies. Accordingly, users can display different images and pictures on the computer monitor/screen, which is useful for holding meetings or improving the look of a room. Alternatively, the window blind component can be pulled down to block out sunlight and maintain a desired aesthetic.

### CROSS-REFERENCE TO RELATED APPLICATION

The present application claims priority to, and the benefit of, U.S. Provisional Application No. 63/437,382, which was filed on Jan. 6, 2023, and is incorporated herein by reference in its entirety.

### FIELD OF THE INVENTION

The present invention relates generally to the field of computer screen blind devices. More specifically, the present invention relates to a combination window blinds and computer monitor that can be installed on any type or size of window. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in computer screen blind devices. Generally, standard window blinds can be effective at blocking out sunlight, but they only have a singular function. People may be looking for more unique and custom blinds that can help block out sunlight while functioning to display different images. Further, work offices may need several computers and monitors to host a meeting. Additionally, many offices are not equipped with blinds and keeping light out of a window can be difficult.

Furthermore, window blinds provide a means to shade incoming light and privacy for the interior of a residence or office window. Normally window blinds have a solid color and most window blinds are white. Since most work office windows comprise window blinds for blocking out sunlight, it would be advantageous to have a device that blocks out sunlight and functions to display images.

Accordingly, a need remains for a window blind device that can also function as a computer screen. Further, a computer screen blind device is necessary to provide multifunctional usage for offices and homes.

Therefore, there exists a long-felt need in the art for a computer screen blind device that provides users with a combination window blind and computer monitor that can be installed on any type or size of window. There is also a long-felt need in the art for a computer screen blind device that features standard window blinds that cover the screen, allowing users to retract them to reveal the monitor as desired. Further, there is a long-felt need in the art for a computer screen blind device that enables users to customize the look and style of the blinds to maintain an aesthetically pleasing look when blocking out sunlight in a room. Moreover, there is a long-felt need in the art for a device that functions as a computer monitor when the blinds are retracted that can be controlled via Bluetooth and other wireless technologies. Further, there is a long-felt need in the art for a computer screen blind device that offers multifunctional usage for homes, offices, etc. Finally, there is a long-felt need in the art for a computer screen blind device that utilizes a decorative window blind.

The subject matter disclosed and claimed herein, in one embodiment thereof, comprises a computer screen blind device. The device is a unique window blind and computer monitor combined into a single device. The computer screen blind device comprises a body component comprised of a computer monitor/screen implemented into a window frame that is covered with a decorative window blind component. Thus, when the window blind component is retracted, the computer monitor/screen is revealed. The computer monitor/screen component would function via Bluetooth or wireless technologies. Accordingly, users can display different images and pictures on the computer monitor/screen component, which is useful for holding meetings or improving the look of a room. Alternatively, the window blind component can be pulled down to block out sunlight and maintain a desired aesthetic.

In this manner, the computer screen blind device of the present invention accomplishes all of the foregoing objectives and provides users with a device that provides a combination window blind and computer monitor. The device enables users to customize the look and style of the window blinds. The device can offer multifunctional usage for homes and offices.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer screen blind device. The device is a unique window blind and computer monitor combined into a single device. The computer screen blind device comprises a body component comprised of a computer monitor/screen implemented into a window frame that is covered with a decorative window blind component. Thus, when the window blind component is retracted, the computer monitor/screen is revealed. The computer monitor/screen component would function via Bluetooth or wireless technologies. Accordingly, users can display different images and pictures on the computer monitor/screen component, which is useful for holding meetings or improving the look of a room. Alternatively, the window blind component can be pulled down to block out sunlight and maintain a desired aesthetic.

In one embodiment, the window blind component can be a series of vertical blinds or horizontal blinds that are used to shade or prohibit an outside view into a window in a home, an office building, etc. The vertical and horizontal blinds function in the manner known and associated with a typical vertical and horizontal blind. The vertical blinds or horizontal blinds can be adjusted into an open position or a closed position. The open position allows users to see out of the window, wherein the closed position prevents users from seeing out of the window. The vertical and horizontal window blind components are made of specific materials suitable for acting as a window blind, as is known in the art.

In one embodiment, the window blind component of the present invention includes a headrail, a bottom rail, a plurality of slats, and a transmission unit. The headrail is fixed on a wall or window frame. The plurality of slats are parallel, and are arranged between the headrail and the bottom rail. Connecting components connect the slats to the headrail and the bottom rail. Each slat is provided with two elongated bores. The bores have two concave edges to form collecting portions.

The slat further is provided with two locking slots at the opposite ends of each bore. Each locking slot has an open end connected to the collecting portion of the bore and a closed end distal to the collecting portion. Precisely, the open end of the locking slot is connected to the narrowest portion of the collecting portion. The locking slot has a constant width.

The transmission unit has two lifting control devices and two cords. The lifting control devices are received in the headrail. Each cord has a control section and a lift section. The control sections are left out of the headrail via an opening to be operated by a user. The lift sections run over the lifting control devices, then pass through the bores of the slats in sequence, and finally are fastened to the bottom rail. A diameter of the lift section is greater than or equal to the width of the locking slot to achieve the best result. The bottom rail is lifted and lowered by pulling or releasing the control sections. Thus, the window blind component operates the same as conventional devices, as is known in the art.

In one embodiment, the computer monitor/screen for displaying images and pictures is made of specific materials suitable for acting as a computer monitor/screen. The computer monitor/screen is typically a roll blind installed in a window frame, and a computer or smart device for displaying images and pictures on the computer monitor/screen communicates with the computer screen via Bluetooth or wireless technologies. The roll blinds of the computer monitor/screen are made of specific materials suitable for acting as a computer monitor/screen and are typically configured in one piece which can be rolled and unrolled.

In one embodiment, the computer monitor/screen comprises a film positioned toward the window to be an outside surface of the computer monitor/screen, further a transparent acryl coating is attached to the film, and a second coating of vinyl is positioned opposite to the window to be an inside surface of the computer monitor/screen. The film is translucent and made by coating synthetic paper, prepared by mixing materials of general high strength vinyl and paper, with use of oil such that the image outputted from the computer can be displayed on the surface thereof. The transparent acryl is made of a polycarbonate film of which thickness is approximately 0.1 mm. The coating vinyl can have various colors harmonic to a user's surroundings. The coating vinyl can also be a smooth film or texture. Depending on circumstances, the computer monitor/screen can be constructed by attaching the film directly to the transparent acryl without the coating vinyl.

In one embodiment, a computer communicates with the computer monitor/screen via Bluetooth or other wireless technologies to project images and pictures onto the computer monitor/screen. In another embodiment, the computer communicates with an LCD projector for displaying variable images and pictures on the computer monitor/screen. The LCD projector comprises variable connecting terminals for permitting connection to a PC, a VCR, a TV, a camcorder, a DVD, etc. For example, when wanting internet images and pictures displayed on the computer monitor/screen, a user connects the PC to the connecting terminal of the LCD projector and then connects with the internet. Then, the LCD projector receives internet image signals from the PC and then displays the image on the computer monitor screen.

In one embodiment, the LCD projector and the computer monitor/screen can communicate via a wire or wireless device.

In one embodiment, the window blind component and the computer monitor/screen are one integral component. Specifically, when in an open position, the window blind component acts as an aesthetic covering and allows a user to see out of the window. Then, when in a closed position, the window blind component functions as a computer monitor/screen and allows users to project images and pictures on the computer monitor/screen. Further, when in a closed position, the window blind component also functions as a shade component to block sun or other light from entering a room.

In one embodiment, the computer monitor/screen is configured as a roller assembly. Generally, the computer monitor/screen comprises a housing with the rolled screen positioned in an interior region of the housing. Preferably, the screen includes a roller rotatably mounted in the housing and the screen is wrapped around the roller. Thus, the screen can then be retracted or lowered, when needed (i.e., before a presentation is projected on the screen). When the presentation is complete, the screen is raised fully or partially back into the housing. In the window blind application, the screen is lowered to cover a window to block light from entering the room. When it is no longer necessary or desirable to block the light from the room, the screen is raised back into the housing.

Depending on the specific application, the housing is shaped and sized to fit the inside of a window frame. Generally, the housing can approximately have a length of not less than 3 feet nor greater than 30 feet. Furthermore, the computer monitor/screen will have a corresponding width to match the length of the housing and an unrolled length of up to 80 feet. Because of the possible length of the screen and the thickness of the fabric or other material comprising the screen, the roller has a diameter of about 6 inches. To accommodate the roller and the screen wrapped on the roller, the housing is relatively large. For example, the housing has a preferred width of about 12 inches and a preferred height of about 10.5 inches. Thus, with a screen having a thickness of about 0.025 inches, the screen may be about 30 feet long. Further, with a screen made of thinner material of about 0.012 inches, the screen may be about 80 feet long.

Accordingly, when supported in the ceiling, window frame, or other structural support of a building, the housing supports the screen to allow for the raising and lowering of the screen between a raised position and a lowered position. In one embodiment, the roller can be powered by a tubular motor that unwinds and winds the screen on the roller during the lowering and raising of the screen. In another embodiment, the roller is manually operated.

According to one embodiment, the screen includes a woven fiberglass backing with a vinyl reflective surface laminated to the fiberglass. According to another embodiment, the screen is made of a white or light gray vinyl material without a backing. Preferably the screen is substantially blank so that it is substantially free of printing or other markings that noticeably detract from the images and pictures projected on the screen. In another embodiment, the substantially blank screen is provided with black borders that frame the screen for “wide screen” or other projection formats.

As previously mentioned, the screen may be also configured to act as a window shade to block or filter light entering a room. Thus, in this embodiment, the screen may have either 100% or less opacity. Further, the screen may be colored to match a particular décor. The outside surface of the screen may match the interior surface or may be white. The screen may be made of a number of materials suitable for shade applications. When total light blockage is desired, a close woven fiberglass material having each surface coated with vinyl may be provided. According to one embodiment, the screen can be insulated to reduce heat loss. When only light filtering is desired, a fabric material is provided having an openness from 3% to 10%. Such material may be woven from polyester yarn or other suitable material. According to alternative embodiments of the present disclosure, the screen can be made of other materials suitable for projection or shade applications.

In yet another embodiment, the computer screen blinds device comprises a plurality of indicia.

In yet another embodiment, a method of utilizing multifunctional window blinds for a computer screen as needed is disclosed. The method includes the steps of providing a computer screen blind device comprising a body component comprised of a computer monitor/screen implemented into a window frame that is covered with a decorative window blind component. The method also comprises securing the computer monitor/screen to a window frame and covering the computer monitor/screen with the window blind component. Further, the method comprises retracting the window blind component, when needed. The method also comprises utilizing the computer monitor/screen as needed to display images and pictures on the screen. Finally, the method comprises extending the window blind component to cover the computer screen when not in use to block out sunlight, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a front perspective view of one embodiment of the computer screen blind device of the present invention showing the device functioning as standard window blinds and as a computer monitor in accordance with the disclosed architecture;

FIG. 2 illustrates a perspective view of one embodiment of the computer screen blind device of the present invention showing how the device can be available in different sizes and function as a screen saver, blackout blind, or projector in accordance with the disclosed architecture; and

FIGS. 3A-B illustrate a perspective view of one embodiment of the computer screen blind device of the present invention showing how the computer monitor component can be paired with Bluetooth and wireless technology to accommodate work meetings in accordance with the disclosed architecture; and

FIG. 4 illustrates a flowchart showing the method of utilizing multifunctional window blinds for a computer screen as needed in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a computer screen blind device that provides users with a combination window blind and computer monitor that can be installed on any type or size of window. There is also a long-felt need in the art for a computer screen blind device that features standard window blinds that cover the screen, allowing users to retract them to reveal the monitor as desired. Further, there is a long-felt need in the art for a computer screen blind device that enables users to customize the look and style of the blinds to maintain an aesthetically pleasing look when blocking out sunlight in a room. Moreover, there is a long-felt need in the art for a device that functions as a computer monitor when the blinds are retracted that can be controlled via Bluetooth and other wireless technologies. Further, there is a long-felt need in the art for a computer screen blind device that offers multifunctional usage for homes, offices, etc. Finally, there is a long-felt need in the art for a computer screen blind device that utilizes a decorative window blind.

The present invention, in one exemplary embodiment, is a novel computer screen blind device. The device is a unique window blind and computer monitor combined into a single device. The computer screen blind device comprises a body component comprised of a computer monitor/screen implemented into a window frame that is covered with a decorative window blind component. Thus, when the window blind component is retracted, the computer monitor/screen is revealed. The computer monitor/screen component would function via Bluetooth or wireless technologies. Accordingly, users can display different images and pictures on the computer monitor/screen component which is useful for holding meetings or improving the look of a room. Alternatively, the window blind component can be pulled down to block out sunlight and maintain a desired aesthetic. The present invention also includes a novel method of utilizing multifunctional window blinds for a computer screen as needed. The method includes the steps of providing a computer screen blind device comprising a body component comprised of a computer monitor/screen implemented into a window frame that is covered with a decorative window blind component. The method also comprises securing the computer monitor/screen to a window frame and covering the computer monitor/screen with the window blind component. Further, the method comprises retracting the window blind component, when needed. The method also comprises utilizing the computer monitor/screen as needed to display images and pictures on the screen. Finally, the method comprises extending the window blind component to cover the computer screen when not in use to block out sunlight, as needed.

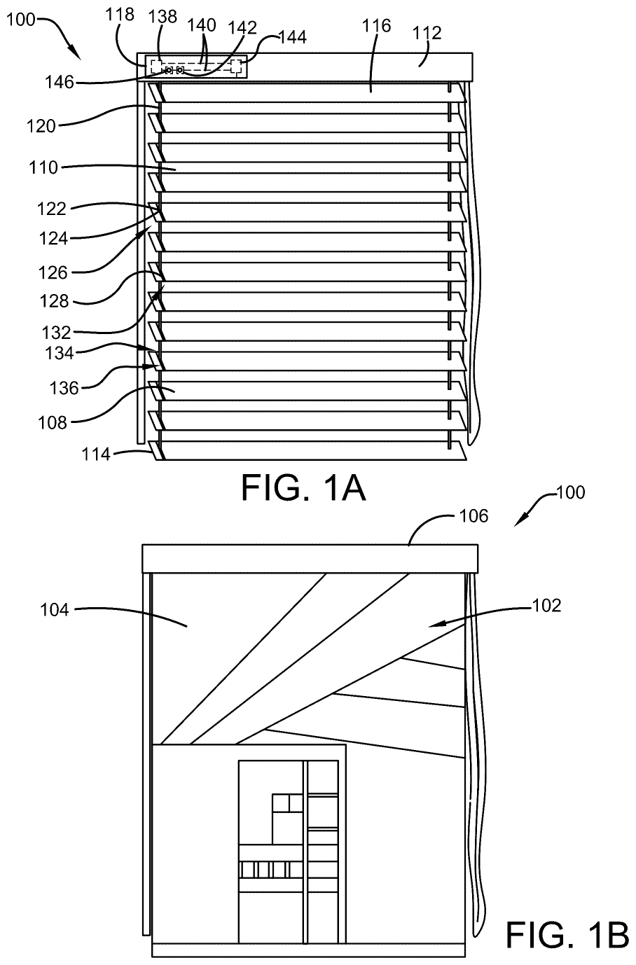

Referring initially to the drawings, FIGS. 1A-B illustrate a perspective view of one embodiment of the computer screen blind device 100 of the present invention. In the present embodiment, the computer screen blind device 100 is an improved computer screen blind device 100 that offers multifunctional usage for homes and offices. The device 100 is a unique window blind and computer monitor combined into a single device. Further, the device 100 is a body component 102 comprised of a computer monitor/screen 104 implemented into a window frame 106 that is covered with a decorative window blind component 108. Thus, when the window blind component 108 is retracted, the computer monitor/screen 104 is revealed. The computer monitor/screen component 104 would function via Bluetooth or wireless technologies. Accordingly, users 300 can display different images and pictures 200 on the computer monitor/screen component 104 which is useful for holding meetings or improving the look of a room. Alternatively, the window blind component 108 can be pulled down to block out sunlight and maintain a desired aesthetic, depending on the needs and/or wants of a user.

Generally, the window blind component 108 can be a series of vertical blinds or horizontal blinds that are used to shade or prohibit an outside view into a window 110 in a home, an office building, etc. The vertical and horizontal blinds function in the manner known and associated with a typical vertical and horizontal blind. The vertical blinds or horizontal blinds can be adjusted into an open position or a closed position. The open position allows users 300 to see out of the window 110, wherein the closed position prevents users 300 from seeing out of the window 110. The vertical and horizontal window blind components are made of specific materials suitable for acting as a window blind 108, as is known in the art.

In one embodiment, the window blind component 108 of the present invention includes a headrail 112, a bottom rail 114, a plurality of slats 116, and a transmission unit 118. The headrail 112 is fixed on a wall or window frame 106. The plurality of slats 116 are parallel and are arranged between the headrail 112 and the bottom rail 114. Connecting components 120 connect the slats 116 to the headrail 112 and the bottom rail 114. Each slat 116 is provided with two elongated bores 122. The bores 122 have two concave edges 124 to form collecting portions 126.

The slat 116 further is provided with two locking slots 128 at the opposite ends 130 of each bore 122. Each locking slot 128 has an open end 132 connected to the collecting portion 126 of the bore 122 and a closed end 134 distal to the collecting portion 126. Precisely, the open end 132 of the locking slot 128 is connected to the narrowest portion of the collecting portion 126. Further, the locking slot 128 has a constant width 136.

The transmission unit 118 has two lifting control devices 138 and two cords 140. The lifting control devices 138 are received in the headrail 112. Each cord 140 has a control section 142 and a lift section 144. The control sections 142 are left out of the headrail 112 via an opening 146 to be operated by a user 300. The lift sections 144 run over the lifting control devices 138, then pass through the bores 122 of the slats 116 in sequence, and finally are fastened to the bottom rail 114. A diameter of the lift section 144 is greater than or equal to the width of the locking slot 128 to achieve the best result. The bottom rail 114 is lifted and lowered by pulling or releasing the control sections 142. Thus, the window blind component 108 operates the same as conventional devices, as is known in the art.

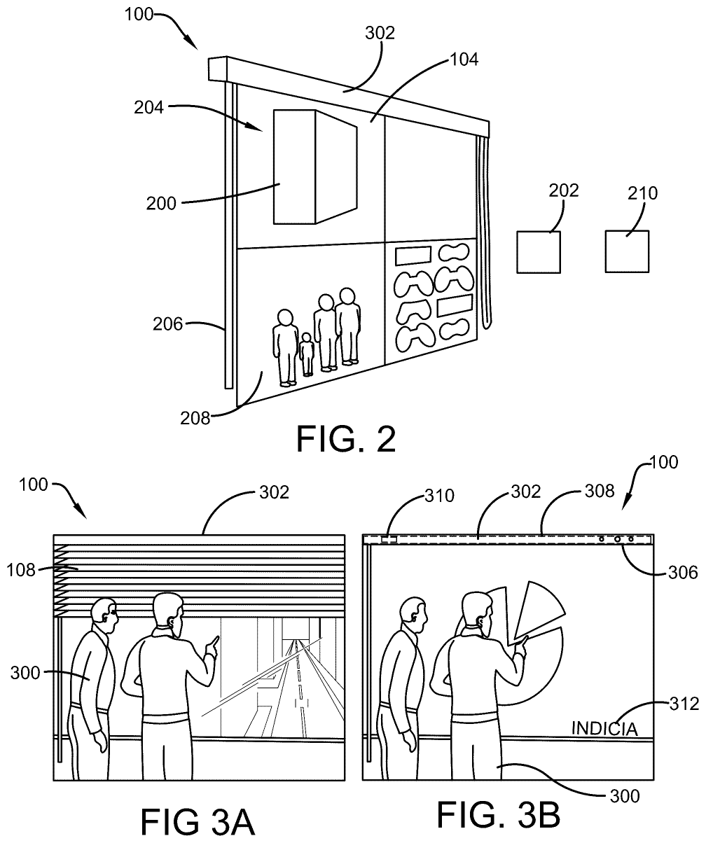

As shown in FIG. 2, the computer monitor/screen 104 for displaying images and pictures 200 is made of specific materials suitable for acting as a computer monitor/screen 104. The computer monitor/screen 104 is typically a roll blind 204 installed in a window frame 106, and a computer or smart device 202 for displaying images and pictures 200 on the computer monitor/screen 104 communicate with the computer screen 104 via Bluetooth or wireless technologies. The roll blinds 204 of the computer monitor/screen 104 are made of specific materials suitable for acting as a computer monitor/screen 104 and are typically configured in one piece which can be rolled and unrolled.

In one embodiment, the computer monitor/screen 104 comprises a film positioned toward the window 110 to be an outside surface 206 of the computer monitor/screen 104, further a transparent acryl coating is attached to the film, and a second coating of vinyl is positioned opposite to the window 100 to be an inside surface 208 of the computer monitor/screen 104. The film is translucent and made by coating synthetic paper, prepared by mixing materials of general high strength vinyl and paper, with use of oil such that the image 200 outputted from the computer 202 can be displayed on the surface thereof. The transparent acryl is made of a polycarbonate film of which thickness is approximately 0.1 mm. The coating vinyl can have various colors harmonic to a user's surroundings. The coating vinyl can also be a smooth film or texture. Depending on circumstances, the computer monitor/screen 104 can be constructed by attaching the film directly to the transparent acryl without the coating vinyl.

Generally, a computer 202 communicates with the computer monitor/screen 104 via Bluetooth or other wireless technologies to project images and pictures 200 onto the computer monitor/screen 104. In another embodiment, the computer 200 communicates with an LCD projector 210 for displaying variable images and pictures 200 on the computer monitor/screen 104. The LCD projector 210 comprises variable connecting terminals for permitting connection to a PC, a VCR, a TV, a camcorder, a DVD, etc. For example, when wanting internet images and pictures 200 displayed on the computer monitor/screen 104, a user 300 connects the PC to the connecting terminal of the LCD projector 210 and then connects with the internet. Then, the LCD projector 210 receives internet image signals from the PC and then displays the image 200 on the computer monitor screen 104.

In one embodiment, the LCD projector 210 and the computer monitor/screen 104 can communicate via a wire or wireless device, as is known in the art and depending on the needs and/or wants of a user 300. Furthermore, the computer screen blind device 100 can be configured in different sizes and shapes as is known in the art, depending on the needs and/or wants of a user. The computer monitor/screen 104 can also function as a screen saver, blackout blind, projector, etc., or any other suitable projection device as is known in the art.

As shown in FIGS. 3A-B, in one embodiment, the window blind component 108 and the computer monitor/screen 104 are one integral component. Specifically, when in an open position, the window blind component 108 acts as an aesthetic covering and allows a user 300 to see out of the window 110. Then, when in a closed position, the window blind component 108 functions as a computer monitor/screen 104 and allows users to project images and pictures 200 on the computer monitor/screen 104. Further, when in a closed position, the window blind component 108 also functions as a shade component to block sun or other light from entering a room.

Generally, the computer monitor/screen 104 is configured as a roller assembly 204. Generally, the computer monitor/screen 104 comprises a housing 302 with the rolled screen 304 positioned in an interior region 306 of the housing 302. Preferably, the screen 304 includes a roller 308 rotatably mounted in the housing 302 and the screen 304 is wrapped around the roller 308. Thus, the screen 304 can then be retracted or lowered, when needed (i.e., before a presentation is projected on the screen 304). When the presentation is complete, the screen 304 is raised fully or partially back into the housing 302. In the window blind application, the screen 304 is lowered to cover a window 110 to block light from entering the room. When it is no longer necessary or desirable to block the light from the room, the screen 304 is raised back into the housing 302.

Depending on the specific application, the housing 302 is shaped and sized to fit the inside of a window frame 106. Generally, the housing 302 can approximately have a length of not less than 3 feet nor greater than 30 feet. Furthermore, the computer monitor/screen 104 will have a corresponding width to match the length of the housing 302 and an unrolled length of up to 80 feet. Because of the possible length of the screen 304 and the thickness of the fabric or other material comprising the screen 304, the roller 308 has a diameter of about 6 inches. To accommodate the roller 308 and the screen 304 wrapped on the roller 308, the housing 302 is relatively large. For example, the housing 302 has a preferred width of about 12 inches and a preferred height of about 10.5 inches. Thus, with a screen 304 having a thickness of about 0.025 inches, the screen 304 may be about 30 feet long. Further, with a screen 304 made of thinner material of about 0.012 inches, the screen 304 may be about 80 feet long.

Accordingly, when supported in the ceiling, window frame 106, or other structural support of a building, the housing 302 supports the screen 304 to allow for the raising and lowering of the screen 304 between a raised position and a lowered position. In one embodiment, the roller 308 can be powered by a tubular motor 310 that unwinds and winds the screen 304 on the roller 308 during the lowering and raising of the screen 304. In another embodiment, the roller 308 is manually operated.

According to one embodiment, the screen 304 includes a woven fiberglass backing with a vinyl reflective surface laminated to the fiberglass. According to another embodiment, the screen 304 is made of a white or light gray vinyl material without a backing. Preferably the screen 304 is substantially blank so that it is substantially free of printing or other markings that noticeably detract from the images and pictures 200 projected on the screen 304. In another embodiment, the substantially blank screen 304 is provided with black borders that frame the screen 304 for “wide screen” or other projection formats.

As previously mentioned, the screen 304 may also be configured to act as a window shade to block or filter light entering a room. Thus, in this embodiment, the screen 304 may have either 100% or less opacity. Further, the screen 304 may be colored to match a particular décor. The outside surface 206 of the screen 304 may match the interior surface 208 or may be white. The screen 304 may be made of a number of materials suitable for shade applications. When total light blockage is desired, a close woven fiberglass material having each surface coated with vinyl may be provided. According to one embodiment, the screen 304 can be insulated to reduce heat loss. When only light filtering is desired, a fabric material is provided having an openness from 3% to 10%. Such material may be woven from polyester yarn or other suitable material. According to alternative embodiments of the present disclosure, the screen 304 can be made of other materials suitable for projection or shade applications.

In yet another embodiment, the computer screen blinds device 100 comprises a plurality of indicia 312. The window blind component 108 and/or the computer monitor/screen 104 of the device 100 may include advertising, trademark, other letters, designs, or characters, printed, painted, stamped, or integrated into the window blind component 108 and/or the computer monitor/screen 104, or any other indicia 312 as is known in the art. Specifically, any suitable indicia 312 as is known in the art can be included, such as but not limited to, patterns, logos, emblems, images, symbols, designs, letters, words, characters, animals, advertisements, brands, etc., that may or may not be window, computer, or brand related.

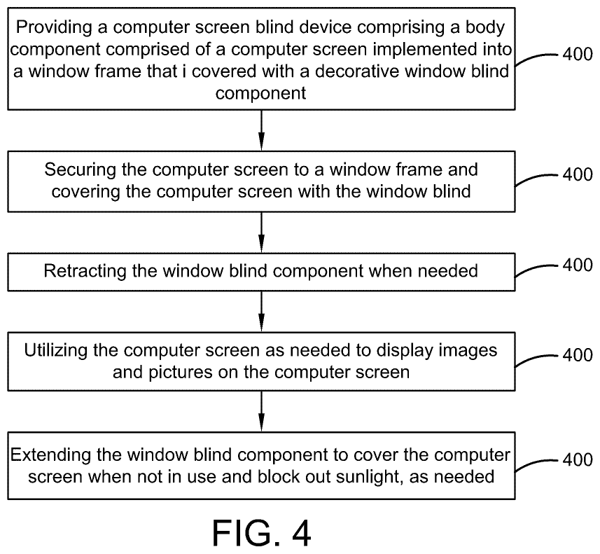

FIG. 4 illustrates a flowchart of the method of utilizing multifunctional window blinds for a computer screen as needed. The method includes the steps of at 400, providing a computer screen blind device comprising a body component comprised of a computer monitor/screen implemented into a window frame that is covered with a decorative window blind component. The method also comprises at 402, securing the computer monitor/screen to a window frame and covering the computer monitor/screen with the window blind component. Further, the method comprises at 404, retracting the window blind component, when needed. The method also comprises at 406, utilizing the computer monitor/screen as needed to display images and pictures on the screen. Finally, the method comprises at 408, extending the window blind component to cover the computer screen when not in use to block out sunlight, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “computer screen blind device”, “computer screen device”, “blind device”, and “device” are interchangeable and refer to the computer screen blind device 100 of the present invention.

Notwithstanding the foregoing, the computer screen blind device 100 of the present invention can be of any suitable size and configuration as is known in the art without affecting the overall concept of the invention, provided that it accomplishes the above-stated objectives. One of ordinary skill in the art will appreciate that the computer screen blind device 100 as shown in FIGS. 1-4 are for illustrative purposes only, and that many other sizes and shapes of the computer screen blind device 100 are well within the scope of the present disclosure. Although the dimensions of the computer screen blind device 100 are important design parameters for user convenience, the computer screen blind device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer screen blind device that offers multifunctional usage for homes and offices, the computer screen blind device comprising:
a body component comprised of a computer screen; and
a window blind component; and
wherein the computer screen is secured within a window frame;
wherein the window blind component acts to cover the computer screen; and
further wherein when the window blind component is retracted, the computer screen is exposed.

2. The computer screen blind device of claim 1, wherein users display images and pictures on the computer screen.

3. The computer screen blind device of claim 2, wherein the window blind component is pulled down to block out sunlight and maintain a desired aesthetic.

4. The computer screen blind device of claim 3, wherein the window blind component is a series of vertical blinds or horizontal blinds.

5. The computer screen blind device of claim 3, wherein the window blind component comprises a headrail, a bottom rail, a plurality of slats, and a transmission unit.

6. The computer screen blind device of claim 5, wherein the headrail is fixed on a window frame, the plurality of slats are parallel and arranged between the headrail and the bottom rail, and connecting components connect the plurality of slats to the headrail and the bottom rail.

7. The computer screen blind device of claim 6, wherein each of the plurality of slats is provided with two elongated bores and two cords to lift and retract the plurality of slats.

8. The computer screen blind device of claim 7, wherein the computer screen communicates with a computer via Bluetooth or another wireless device to project images and pictures.

9. The computer screen blind device of claim 7, wherein the computer screen communicates with an LCD projector via Bluetooth or another wireless device to project images and pictures.

10. The computer screen blind device of claim 7 further comprising a plurality of indicia.

11. The computer screen blind device of claim 7, wherein the computer screen also functions as a screen saver, a blackout blind, or a projector.

12. The computer screen blind device of claim 1, wherein the window blind component and the computer screen are one integral component.

13. The computer screen blind device of claim 12, wherein the computer screen is configured as a roller assembly comprising a housing with a rolled screen wrapped around a roller and positioned in an interior region of the housing.

14. A computer screen blind device that offers multifunctional usage for homes and offices, the computer screen blind device comprising:
a body component comprised of a computer screen; and
a window blind component; and
wherein the computer screen is secured within a window frame;
wherein the computer screen is configured as a roller assembly comprising a housing with a rolled screen wrapped around a roller and positioned in an interior region of the housing;
wherein the window blind component acts to cover the computer screen;
wherein when the window blind component is retracted, the computer screen is exposed;
wherein users display images and pictures on the computer screen; and
further wherein the window blind component is pulled down to block out sunlight and maintain a desired aesthetic.

15. The computer screen blind device of claim 14 further comprising a plurality of indicia.

16. The computer screen blind device of claim 14, wherein the computer screen communicates with a computer via Bluetooth or another wireless device to project images and pictures.

17. The computer screen blind device of claim 14, wherein the computer screen communicates with an LCD projector via Bluetooth or another wireless device to project images and pictures.

18. The computer screen blind device of claim 14, wherein the computer screen also functions as a screen saver, a blackout blind, or a projector.

19. The computer screen blind device of claim 14, wherein the window blind component and the computer screen are one integral component.

20. A method of utilizing multifunctional window blinds for a computer screen as needed, the method comprising the following steps:
providing a computer screen blind device comprising a body component comprised of a computer screen implemented into a window frame that is covered with a decorative window blind component;
securing the computer screen to a window frame and covering the computer screen with the window blind component;
retracting the window blind component, when needed;
utilizing the computer screen as needed to display images and pictures on the computer screen; and
extending the window blind component to cover the computer screen when not in use to block out sunlight, as needed.
